(19) United States
(12) Patent Application Publication
(10) Pub. No.: US 2025/0142513 A1
(43) Pub. Date: May 1, 2025

(54) POSITIONING AND TRACKING USING LOW-EARTH ORBIT (LEO) SATELLITES

(71) Applicant: Toyota Motor Engineering & Manufacturing North America, Inc., Plano, TX (US)

(72) Inventors: Takayuki Shimizu, Santa Clara, CA (US); Akila C. Ganlath, Fremont, CA (US)

(73) Assignees: Toyota Motor Engineering & Manufacturing North America, Inc., Plano, TX (US); Toyota Jidosha Kabushiki Kaisha, Toyota-shi (JP)

(21) Appl. No.: 18/605,396

(22) Filed: Mar. 14, 2024

Related U.S. Application Data
(60) Provisional application No. 63/594,229, filed on Oct. 30, 2023.

(51) Int. Cl. H04W 64/00; H04W 84/06

(52) U.S. Cl. CPC H04W 64/00; H04W 84/06

(57) ABSTRACT

Systems, methods, and other embodiments described herein relate to using non-terrestrial network (NTN) nodes, such as low-earth orbit (LEO) satellites, to provide location services. In one embodiment, a method includes establishing a communication link from a device to a non-terrestrial network (NTN) node. The method includes acquiring environmental characteristics associated with the device and the NTN node. The method includes determining whether a signal from the NTN node is a non-line-of-sight (NLOS) signal according to the environmental characteristics. The method includes computing a position of the device using the signal and a compensation parameter when the signal is NLOS. The method includes providing the position.

### CROSS-REFERENCE TO RELATED APPLICATIONS

This application claims benefit of U.S. Provisional Application No. 63/594,229, filed on, Oct. 30, 2023, which is herein incorporated by reference in its entirety.

### TECHNICAL FIELD

The subject matter described herein relates, in general, to using satellites, such as low-earth orbit (LEO) satellites, to provide location services and, more particularly, to implementing an approach for determining locations in line-of-sight and non-line-of-sight contexts using satellites.

### BACKGROUND

Determining the location of a device within a global context is a powerful technology. That is, location services within smartphones and vehicles permit the implementation of many different services, such as navigation, emergency services, and so on. To provide location services, systems generally rely on geosynchronous satellites that communicate particular signals to facilitate determining the location of a respective device. In other approaches, systems may rely on triangulation techniques using cellular towers or Wi-Fi signals. However, as new means for communicating arise, the potential for transitioning location services to other modalities or supplementing existing modalities become possible. In particular, low-earth orbit (LEO) satellites are becoming more common for providing connectivity. Thus, LEO satellites may be useful for providing location services. However, several difficulties exist when using LEO satellites for location services that are unique. As one example, unlike global navigation satellite system (GNSS) satellites, which are equipped with precise clocks, LEO satellites do not generally include these precise clocks, which can further complicate using such signals for positioning. Additionally, non-line-of-sight positioning for LEO satellites adds additional complications not seen in other modalities. Therefore, various complications exist that must be overcome before it is practical to use LEO satellites for positioning.

### SUMMARY

In various embodiments, example systems and methods relate to using low-earth orbit (LEO) satellites to provide location services. As previously noted, LEO satellites represent specific difficulties in relation to using such satellites for positioning a device. For example, in comparison to GNSS satellites, which have a higher orbit and a stationary or slow-moving trajectory, LEO satellites operate in a low orbit and have a faster perceived trajectory from the surface of the Earth, thereby resulting in further difficulties when determining an accurate path of the signals from which positioning information is derived. In particular, various approaches generally consider only static objects or reflectors when performing shadow matching, such as buildings, in NLOS instances. As a result, the use of LEO satellites for providing location services is limited.

Therefore, in one or more embodiments, an inventive system is disclosed that functions to overcome the noted difficulties and thereby provide for using signals from LEO satellites for location services. Moreover, while LEO satellites are generally described herein, it should be appreciated that the disclosed systems and methods may be further applied to non-terrestrial network (NTN) nodes, such as a low-Earth orbit (LEO) satellite, medium Earth orbit (MEO) satellite, or geostationary orbit (GEO) satellite. For example, in at least one approach, a terminal, (e.g., a vehicle, mobile device, etc.) initially establishes a communication link with one or more LEO satellites. The communication link may be established links for bi-directional communications or simply acquiring the signals either actively (e.g., via beam management procedures) or passively (e.g., without using an LEO satellite's position). Accordingly, initially, the terminal may not be aware of whether the signal is line-of-sight (LOS) or non-line-of-sight (NLOS).

To determine the character of the signal, the terminal collects various information and analyzes the information. This may include acquiring various radio propagation metrics. As one example, the terminal may use reference signals within a received LEO signal to determine whether the signal is NLOS or LOS. In a further example, the system may use a combination of metrics about the signal itself and/or information about the surrounding environment as acquired by sensors associated with the terminal (e.g., sensors of a vehicle in which the terminal is embedded). That is, the terminal can actively perceive the surrounding environment and determine whether positions of dynamic objects relative to the LEO satellites cause the signal to be reflected as a NLOS signal.

In any case, once the terminal determines whether the signal is NLOS or LOS, the system can then further use the acquired information to estimate a position of the terminal. When the signal is NLOS, the system may generate a compensation parameter to adjust for positioning error. This may involve the terminal estimating characteristics of a dynamic object (e.g., size, position, speed, heading, etc.) to gauge a relative distance and angle of the dynamic object from the terminal and in relation to the LEO satellite. From this information, the system can then estimate the path of the signal and determine the compensation parameter. Similarly, in the context of reconfigurable intelligent surfaces (RIS), the terminal can use a rough position of the RIS, a direction of the RIS, and a reflection angle currently used by the RIS and determine a path of the signal accordingly. As such, the terminal is then able to determine a position from this NLOS information. The terminal may then provide the position information to other systems in order to facilitate various functionality, such as navigation, and so on. In this way, the system improves the availability of positioning information by enabling the use of LEO satellites for location services in NLOS contexts.

In one embodiment, a positioning system is disclosed. The connection system includes one or more processors and a memory communicably coupled to the one or more processors. The memory stores a control module including instructions that, when executed by the one or more processors, cause the one or more processors to establish a communication link from a device to a non-terrestrial network (NTN) node. The instructions include instructions to acquire environmental characteristics associated with the device and the NTN node. The instructions include instructions to determine whether a signal from the NTN node is a non-line-of-sight (NLOS) signal according to the environmental characteristics. The instructions include instructions to compute a position of the device using the signal and a compensation parameter when the signal is NLOS. The instructions include instructions to provide the position

In one embodiment, a non-transitory computer-readable medium including instructions that, when executed by one or more processors, cause the one or more processors to perform one or more functions is disclosed. The instructions include instructions to establish a communication link from a device to a non-terrestrial network (NTN) node. The instructions include instructions to acquire environmental characteristics associated with the device and the NTN node. The instructions include instructions to determine whether a signal from the NTN node is a non-line-of-sight (NLOS) signal according to the environmental characteristics. The instructions include instructions to compute a position of the device using the signal and a compensation parameter when the signal is NLOS. The instructions include instructions to provide the position.

In one embodiment, a method is disclosed. In one embodiment, the method includes establishing a communication link from a device to a non-terrestrial network (NTN) node. The method includes acquiring environmental characteristics associated with the device and the NTN node. The method includes determining whether a signal from the NTN node is a non-line-of-sight (NLOS) signal according to the environmental characteristics. The method includes computing a position of the device using the signal and a compensation parameter when the signal is NLOS. The method includes providing the position.

### BRIEF DESCRIPTION OF THE DRAWINGS

The accompanying drawings, which are incorporated in and constitute a part of the specification, illustrate various systems, methods, and other embodiments of the disclosure. It will be appreciated that the illustrated element boundaries (e.g., boxes, groups of boxes, or other shapes) in the figures represent one embodiment of the boundaries. In some embodiments, one element may be designed as multiple elements, or multiple elements may be designed as one element. In some embodiments, an element shown as an internal component of another element may be implemented as an external component and vice versa. Furthermore, elements may not be drawn to scale.

FIG. 1 illustrates one embodiment of a vehicle within which systems and methods disclosed herein may be implemented.

FIG. 2 illustrates one embodiment of a positioning system associated with using low-Earth orbit (LEO) satellites to determine the position of a device.

FIG. 3 illustrates a diagram of a connection system within a cloud-computing environment.

FIG. 4 is a diagram illustrating a basic configuration of satellite-based communication.

FIG. 5 illustrates different arrangements of LOS and NLOS signals between an LEO satellite and a vehicle.

FIG. 6 is a flowchart illustrating one embodiment of a method associated with using LEO satellites to determine the position of a device.

### DETAILED DESCRIPTION

Systems, methods, and other embodiments associated with using low-earth orbit (LEO) satellites to provide location services are disclosed. As previously noted, LEO satellites represent specific difficulties in relation to using such satellites for positioning a device. For example, in comparison to GNSS satellites, which have a higher orbit and a stationary or slow-moving trajectory, LEO satellites operate in a low orbit and have a faster perceived trajectory, thereby resulting in further difficulties when determining an accurate path of the signals from which positioning information is derived. In particular, various approaches generally consider only static objects or reflectors when performing shadow matching, such as buildings, in NLOS instances. As a result, the use of LEO satellites for providing location services is limited.

Therefore, in one or more embodiments, an inventive system is disclosed that functions to overcome the noted difficulties and thereby provide for using signals LEO satellites for location services. Moreover, while LEO satellites are generally described herein, it should be appreciated that the disclosed systems and methods may be further applied to non-terrestrial network (NTN) nodes, such as a low-Earth orbit (LEO) satellite, medium Earth orbit (MEO) satellite, or geostationary orbit (GEO) satellite. For example, in at least one approach, a terminal (e.g., a vehicle, mobile device, etc.) initially establishes a communication link with one or more LEO satellites. The communication link may be established links for bi-directional communications or simply acquiring the signals either actively (e.g., via beam management procedures) or passively (e.g., without using an LEO satellite's position). Accordingly, initially, the terminal may not be aware of whether the signal is line-of-sight (LOS) or non-line-of-sight (NLOS).

To determine the character of the signal, the terminal collects various information and analyzes the information. This may include acquiring various radio propagation metrics. As one example, the terminal may use reference signals within a received LEO signal to determine whether the signal is NLOS or LOS. In a further example, the system may use a combination of metrics about the signal itself and/or information about the surrounding environment as acquired by sensors associated with the terminal (e.g., sensors of a vehicle in which the terminal is embedded). That is, the terminal can actively perceive the surrounding environment and determine whether positions of dynamic objects relative to the LEO satellites cause the signal to be reflected as a NLOS signal.

In any case, once the terminal determines whether the signal is NLOS or LOS, the system can then further use the acquired information to estimate a position of the terminal. When the signal is NLOS, the system may generate a compensation parameter to adjust for positioning error. This may involve the terminal estimating characteristics of a dynamic object (e.g., size, position, speed, heading, etc.) to gauge a relative distance and angle of the dynamic object from the terminal and in relation to the LEO satellite or other NTN node. From this information, the system can then estimate the path of the signal and determine the compensation parameter. Similarly, in the context of reconfigurable intelligent surfaces (RIS), the terminal can use a rough position of the RIS, a direction of the RIS, and a reflection angle currently used by the RIS and determine a path of the signal accordingly. As such, the terminal is then able to determine a position from this NLOS information. The terminal may then provide the position information to other systems in order to facilitate various functionality, such as navigation, and so on. In this way, the system improves the availability of positioning information by enabling the use of LEO satellites for location services in NLOS contexts.

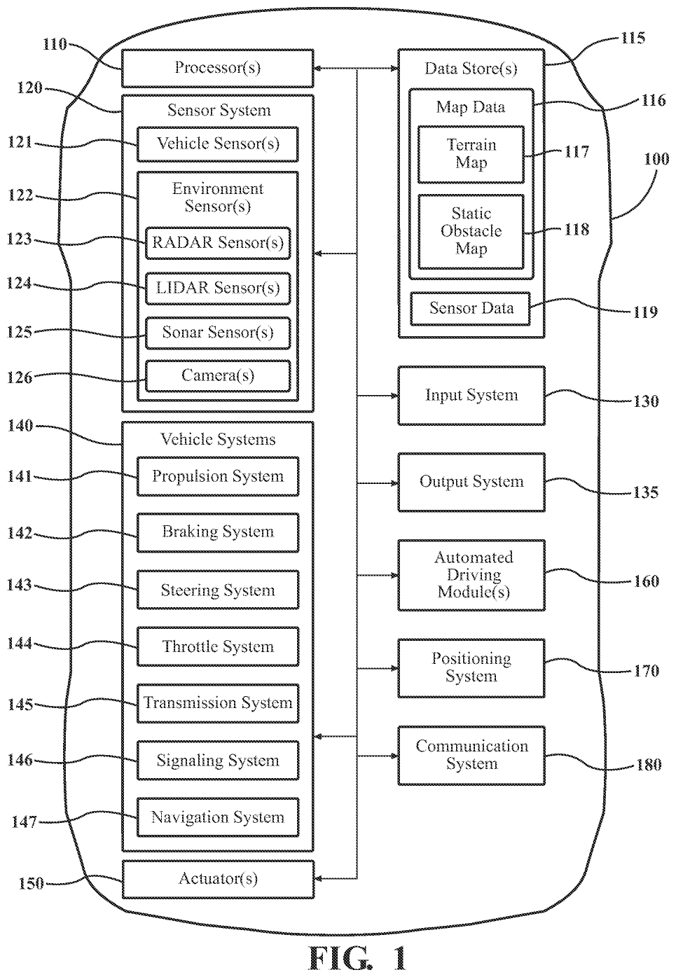

Referring to FIG. 1, an example of a vehicle 100 is illustrated. As used herein, a “vehicle” is any form of powered transport. In one or more implementations, the vehicle 100 is an automobile. While arrangements will be described herein with respect to automobiles, it will be understood that embodiments are not limited to automobiles. In some implementations, the vehicle 100 may be any device that, for example, transports passengers. In various approaches, the vehicle 100 may be an automated vehicle. Thus, the vehicle 100 may operate autonomously, semi-autonomously, or with the assistance of various advanced driving assistance systems (ADAS). In still further aspects, the vehicle 100 may instead by a handheld device (e.g., a smartphone), a maritime vehicle, an aerial vehicle (e.g., a plane, drone, etc.), and so on.

Further, the vehicle 100 may be a connected vehicle that is capable of communicating wirelessly with other devices, such as other connected vehicles, infrastructure elements (e.g., roadside units), cloud-computing elements, and so on. Moreover, while the present disclosure is generally described in relation to the vehicle 100, in yet further approaches, the noted systems and methods disclosed herein may be implemented as part of other entities, such as electronic devices that are not associated with a particular form of transport but are instead embedded as part of a mobile electronic device (e.g., smartphone) that can be, for example, carried by an individual and that may function independently or in concert with additional systems of other devices.

In any case, the vehicle 100 also includes various elements. It will be understood that, in various embodiments, it may not be necessary for the vehicle 100 to have all of the elements shown in FIG. 1. The vehicle 100 can have any combination of the various elements shown in FIG. 1. Further, the vehicle 100 can have additional elements to those shown in FIG. 1. In some arrangements, the vehicle 100 may be implemented without one or more of the elements shown in FIG. 1. While the various elements are shown as being located within the vehicle 100 in FIG. 1, it will be understood that one or more of these elements can be located external to the vehicle 100. Further, the elements shown may be physically separated by large distances. For example, as discussed, one or more components of the disclosed system can be implemented within the vehicle 100, while further components of the system are implemented within a cloud-based environment, as discussed further subsequently.

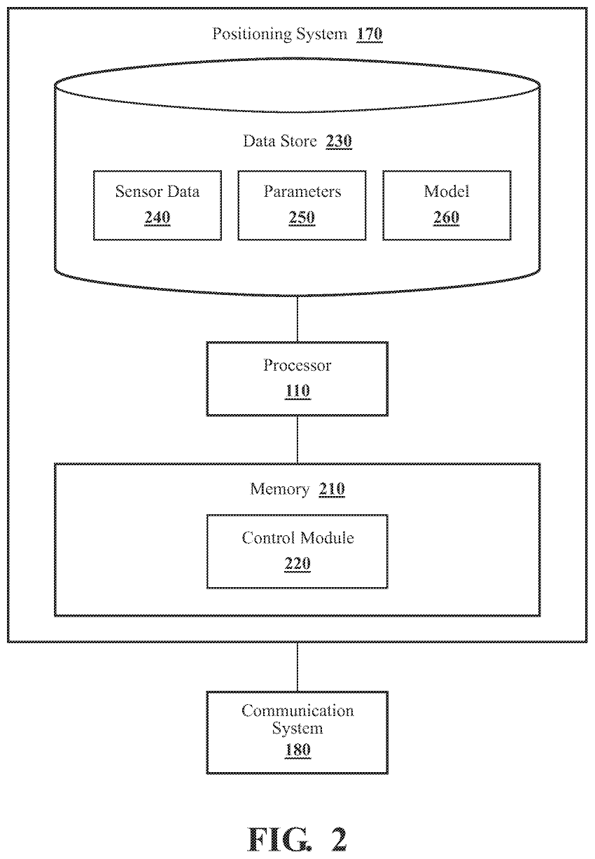

Some of the possible elements of the vehicle 100 are shown in FIG. 1 and will be described along with subsequent figures. However, a description of many of the elements in FIG. 1 will be provided after the discussion of FIGS. 2-6 for purposes of the brevity of this description. Additionally, it will be appreciated that for simplicity and clarity of illustration, where appropriate, reference numerals have been repeated among the different figures to indicate corresponding or analogous elements. In addition, the discussion outlines numerous specific details to provide a thorough understanding of the embodiments described herein. Those of skill in the art, however, will understand that the embodiments described herein may be practiced using various combinations of these elements. In any case, as illustrated in the embodiment of FIG. 1, the vehicle 100 includes a positioning system 170 that is implemented to perform methods and other functions as disclosed herein relating to improving how the vehicle 100 establishes a connection with a mobile device, such as another vehicle.

Moreover, the positioning system 170, as provided for within the vehicle 100, can function in cooperation with a communication system 180. In one embodiment, the communication system 180 communicates according to one or more communication standards. For example, the communication system 180 can include multiple different antennas/transceivers and/or other hardware elements for communicating at different frequencies and according to respective protocols. The communication system 180, in one arrangement, communicates via a communication protocol, such as a GNSS, WiFi, DSRC, vehicle to everything (V2X) (e.g., vehicle to infrastructure (V2I), vehicle to vehicle (V2V)), or another suitable protocol for communicating between the vehicle 100 and other entities. Moreover, the communication system 180, in one arrangement, further communicates according to a protocol, such as global system for mobile communication (GSM), Enhanced Data Rates for GSM Evolution (EDGE), Long-Term Evolution (LTE), 5G, or another communication technology that provides for the vehicle 100 communicating with various remote devices (e.g., a cloud-based server, an edge server, a roadside unit (RSU)). The various communications and protocols may further include cellular communications, such as code-division multiple access (CDMA), time-division multiple access (TDMA), frequency-division multiple access (FDMA), single-carrier FDMA (SC-FDMA), orthogonal frequency-division multiple access (OFDMA), and so on. Additionally, the communication system 180 is able, in at least one configuration, to communicate via a protocol for non-terrestial networks (NTN) associated with LEO, medium earth orbit (MEO), and geostationary orbit (GEO) satellite communications as are specified in various 3GPP standards and others. For example, the communication system 180 can communicate via new radio NTN (NR-NTN) and IoT-NTN. In any case, the positioning system 170 can leverage various wireless communication technologies to provide communications to other entities, such as a remote server, other vehicles, and so on.

With reference to FIG. 2, one embodiment of the positioning system 170 is further illustrated. The positioning system 170 is shown as including a processor 110 from the vehicle 100 of FIG. 1. Accordingly, the processor 110 may be a part of the positioning system 170, the positioning system 170 may include a separate processor from the processor 110 of the vehicle 100 or the positioning system 170 may access the processor 110 through a data bus or another communication path. In further aspects, the processor 110 is a cloud-based resource. Thus, the processor 110 may communicate with the positioning system 170 through a communication network or may be co-located with the positioning system 170. In one embodiment, the positioning system 170 includes a memory 210 that stores a control module 220. The memory 210 is a random-access memory (RAM), read-only memory (ROM), a hard-disk drive, a flash memory, or other suitable memory (either volatile or non-volatile) for storing the control module 220 and/or other information used by the positioning system 170. The module 220 is, for example, computer-readable instructions within the physical memory 210 that, when executed by the processor 110, cause the processor 110 to perform the various functions disclosed herein.

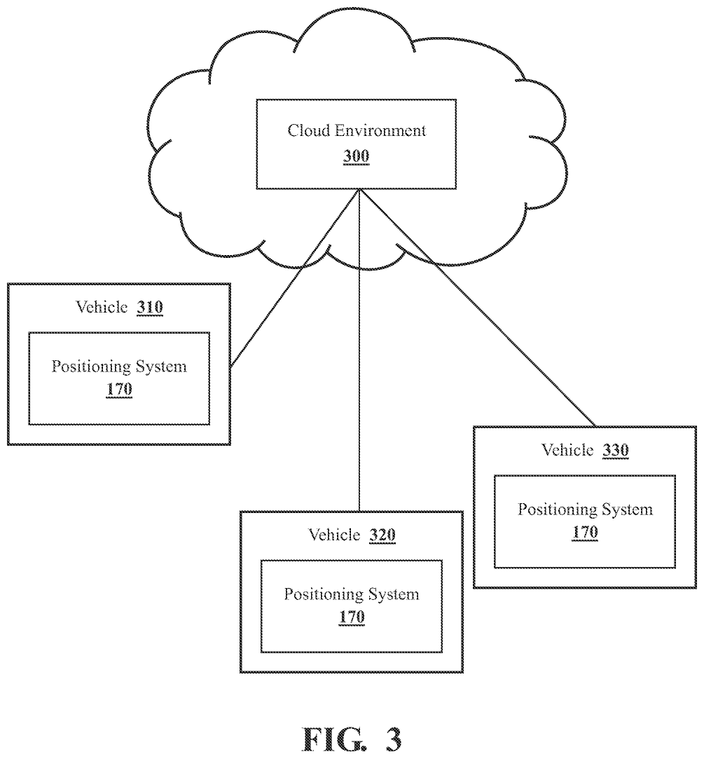

As previously noted, the positioning system 170 may be further implemented within the vehicle 100 as part of a cloud-based system that functions within a cloud environment 300, as illustrated in relation to FIG. 3. That is, for example, the positioning system 170 may acquire data (e.g., parameters for establishing a connection) from a remote server that is integrated as part of the cloud environment 300. In one or more approaches, the cloud environment 300 may facilitate the exchange of information between entities (e.g., vehicles 310, 320, and 330) or function to perform various processing tasks, as described further subsequently, on behalf of a client version of the system 170 installed within the vehicle 100.

Accordingly, as shown, the positioning system 170 may include separate instances within one or more entities of the cloud-based environment 300, such as servers, and also instances within vehicles 310-330 that function separately. In a further aspect, the entities that implement the positioning system 170 within the cloud-based environment 300 may vary beyond transportation-related devices and encompass mobile devices (e.g., smartphones), and other such devices that may be carried by an individual. Thus, the set of entities that function in coordination with the cloud environment 300 may be varied.

Continuing with FIG. 2 and a general embodiment of the positioning system 170, in one or more arrangements, the positioning system 170 includes a data store 230. The data store 230 is, in one embodiment, an electronic data structure (e.g., a database) stored in the memory 210 or another electronic memory and that is configured with routines that can be executed by the processor 110 for analyzing stored data, providing stored data, organizing stored data, and so on. Thus, in one embodiment, the data store 230 stores data used by the module 220 in executing various functions. In one embodiment, the data store 230 includes sensor data 240, parameters 250, a model 260, and/or other information that is used by the module 220. It should be appreciated that while the data store 240 is shown as including the noted elements, separate instances of the positioning system 170 may implement the data store 230 to include different sets of information.

The control module 220 generally includes instructions that function to control the processor 110 to receive data inputs from one or more sensors of the vehicle 100. The inputs are, in one embodiment, observations of an environment proximate to the vehicle 100 and/or other aspects about the surroundings. As provided for herein, the control module 220, in one embodiment, acquires sensor data 240 that includes, for example, camera images. In further arrangements, the control module 220 acquires the sensor data 240 from further sensors such as a radar 123, a LIDAR 124, and other sensors as may be suitable for identifying dynamic objects. In yet further aspects, the control module 220 may acquire information about the vehicle 100 itself, such as data from an IMU, wheel speed sensor, steering angle sensor, altimeter, etc.), which may be useful in determining relative positions/trajectories of the vehicle 100 with the dynamic objects.

Accordingly, the control module 220, in one embodiment, controls the respective sensors to provide the data inputs in the form of the sensor data 240. Additionally, while the control module 220 is discussed as controlling the various sensors to provide the sensor data 240, in one or more embodiments, the control module 220 can employ other techniques to acquire the sensor data 240 that are either active or passive. For example, the control module 220 may passively sniff the sensor data 240 from a stream of electronic information provided by the various sensors to further components within the vehicle 100. Moreover, the control module 220 can undertake various approaches to fuse data from multiple sensors when providing the sensor data 240 and/or from sensor data acquired over a wireless communication link (e.g., V2X) from one or more other sources, such as the surrounding vehicles and/or infrastructure devices. Thus, the sensor data 240, in one embodiment, represents a combination of perceptions acquired from multiple sensors. The sensor data 240 may include, for example, information about objects in the surrounding environment that are capable of blocking satellite signals from being received by the communication system 180, and so on.

In general, the positioning system 170 can use the sensor data 240 about the surrounding environment to identify the presence of dynamic objects. The dynamic objects can include vehicles, such as cars, trucks, and so on. The dynamic objects may further include other large objects that move, such as ships, construction equipment, and so on. Broadly, the system 170 is identifying aspects of the environment that are not static, i.e., dynamic objects that can move or are moving, and that can block signals from NTN nodes, such as LEO satellites, so that the system 170 can then compensate for reflections of the signals in the resulting NLOS paths, as will be discussed further subsequently. In any case, it should be appreciated that the control module 220 is able to identify objects, determine a shape and location of the object in the surrounding environment, and determine whether the object blocks a LOS with an LEO satellite with which the positioning system 170 is communicating. In various approaches, the functions of identifying the objects, determining the location, and so on may involve the implementation of various processing techniques, such as machine learning. It should be further noted that in the case of the vehicle 100 being autonomous or semi-autonomous at least part of the functionality may be undertaken by the automated driving module 160 as an existing capability.

Turning to the parameters 250, the control module 220 further includes instructions to determine the parameters 250 through, for example, measurement of radio propagation metrics from a signal. The control module 220 can measure angle of arrival (AoA), angle of departure (AoD), round-trip time (RTT), Doppler shift, and carrier phase. In yet a further aspect, the parameters 250 can include a comparison or difference between the listed metrics of two separate LEO satellites. In addition to the explicit parameters, the control module 220 can further determine other parameters about the LEO satellites and the terminal (i.e., the vehicle 100), including a current rough position of the terminal, a current position/direction of the LEO satellite as may be determined according to adjusting a beam direction, surrounding object information (e.g., static buildings, etc.). As will be described further subsequently, the control module 220 can use the parameters 250 and/or the sensor data 240 to determine aspects such as whether the signals are LOS or NLOS.

Lastly, the data store 230 is shown as including the model 260. The model 260 is, in one or more arrangements, a machine-learning model, such as a deep neural network (DNN) that is trained to accept the sensor data 240 and/or the parameters 250 as an input and provides a compensation parameter for NLOS signals or a final position of the terminal, thereby considering all of the noted elements and also performing analysis of the geometric relationship between the terminal and the LEO satellite along with an intervening reflection to provide the position. The specific approach will be further described subsequently.

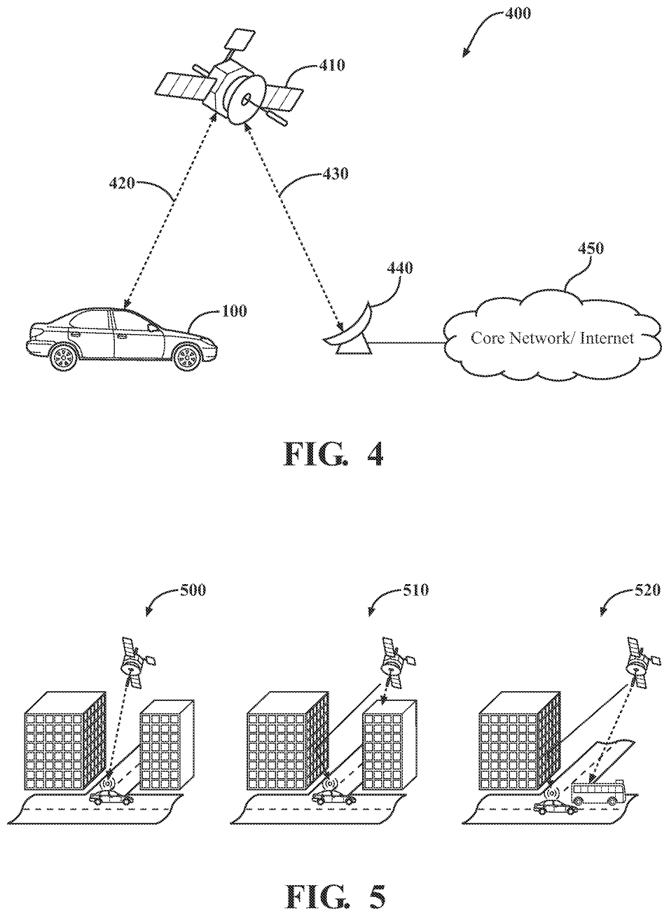

Continuing with the functionality of the control module 220, initially, the control module 220 establishes a communication link with one or more LEO satellites. With reference to FIG. 4, a general arrangement of a context 400 with a LEO satellite 410 is shown. As illustrated and discussed, the vehicle 100/system 170 is establishing a service link 420 between the vehicle 100 and the satellite 410. It should be appreciated that while the positioning system 170 can establish the service link 420 in a functional sense for providing explicit payloads of information, in other arrangements, the positioning system 170 may use existing signals from the satellite 410 without establishing an explicit communication channel therebetween. In any case, the LEO satellite 410 typically functions to provide communications between the vehicle 100 or another terminal via the service link 420 and a feeder link 430 to gateway/ground station 440 that connects with a core network 450, such as the Internet.

The NTN nodes, including the LEO satellites, may be LOS or NLOS from the vehicle 100. However, the control module 220 is generally unaware of whether the satellites are NLOS or not at this point. In the case of NLOS signals, various aspects of the surrounding environment reflect the signal, resulting in propagation of the signal along a longer path through the environment before reaching the vehicle 100. The reflections can be caused by static aspects of the environment, such as buildings, geographic features, reflectors/repeaters, etc., and/or dynamic aspects, such as vehicles (e.g., semi-trucks).

It should be noted that while the examples in this disclosure relate to LEO satellites, the disclosed approaches may be used in relation to other satellite systems such as MEO, GEO, and others, which may be broadly referred to as NTN nodes. Additionally, the satellite can be either a transparent payload or a regenerative payload. The signals themselves can be from various satellite communication spectrum, including but not limited to L band (1-2 GHZ), S band (2-4 GHz), Ku band (12-18 GHZ), and Ka band (27-40 GHZ). Furthermore, the positioning system 170/communication system 180 can communicate according to various wireless communication protocols, such as 3GPP and IEEE 802 radio technologies, e.g., 3G, 4G, 5G technologies, future 3GPP radio technologies such as 6G, IEEE 802.11 technologies. In general, the hardware radio(s) of the vehicle 100 may be embedded within the communication system 180, and the positioning system 170 may include separate logic that functions in combination with the communication system 180. In further aspects, the system 170 and 180 may be integrated together as a discrete system.

In any case, to establish the communication link, the positioning system 170 performs a beam management procedure, such as initial beam pairing, to establish the link. In further arrangements, the control module 220 establishes the link using a direct LOS with the LEO satellite. That is, the control module 220 adjusts a beam direction towards the LOS direction of the LEO satellite according to an estimated current position/direction of the LEO satellite derived from ephemeris or trajectory of the LEO satellite.

In yet further arrangements, the control module 220 establishes the link via a NLOS signal that is reflected by static and/or dynamic objects in the environment. In this case, the control module 220 initially estimates or obtains information otherwise about how the objects reflect the signal. Thus, the control module 220 may acquire the sensor data 240 about the surrounding environment and identify objects and associated shapes and positions. The control module 220 may separately acquire the information from another source, such as a cloud-based source, another device in the local environment, and so on. In addition to using the sensor data 240 to identify dynamic objects, the control module 220 may use 3D mappings to identify static objects. Thus, the control module 220 can then use the acquired information to adjust a beam direction towards the NLOS signal path.

In yet a further arrangement, the control module 220 establishes the link using NLOS signals reflected or repeated by reflectors/repeaters. For example, the control module 220 may use signals reflected by a reconfigurable intelligent surface (RIS) that may be installed on a building. In this case, the control module 220 uses information about the RIS (e.g., position, direction) to adjust a beam direction toward the RIS and the RIS may further use a position of the vehicle 100 to adjust a reflection angle in order to facilitate establishing the connection.

Once the control module 220 establishes the initial communication link, the control module 220 determines whether the signal from the LEO satellite is LOS or NLOS. It should be noted that while the acquisition of the sensor data 240 and the parameters 250 is discussed in combination with multiple separate aspects of the present approach, the system 170 may acquire the information in parallel and/or at multiple separate instances to support the separate functions. As a brief explanation of LOS versus NLOS signals, consider FIG. 5. FIG. 5 illustrates different arrangements of LOS and NLOS signals between an LEO satellite and a vehicle. For example, a LOS signal is shown in example 500. The LOS signal is unobstructed between the LEO satellite and the terminal (i.e., vehicle 100). While static obstructions exist in example 500, the positioning of the satellite relative to the terminal still provides for a direct unobstructed view and thus a direct path therebetween without any reflections. Example 510 illustrates one example of a NLOS signal. In this example, a direct path between the LEO satellite and the terminal is blocked by a static obstacle in the form of the building. Accordingly, as illustrated, the signal reflects off of another building before being received by the terminal. This can result in positioning error if the terminal terminal fails to account for the reflection of the NLOS signal. Example 520 shows an example of a NLOS that is due to a dynamic object. In this example, a NLOS signal results from a large vehicle (e.g., a bus) obstructing the path of the signal between the terminal and the LEO satellite. As can be appreciated, the vehicle (i.e., terminal) may drive alongside the bus, obstructing the direct path between the satellite and the terminal. In the example 520, the NLOS signal is shown as reflecting off of a static structure, but the signal may also reflect from other dynamic objects in the environment.

Accordingly, the control module 220 includes instructions to determine whether the signal is NLOS or not. In one approach, the control module 220 measures radio propagation metrics (e.g., the parameters 250) of the signal using a reference signal within the received signal. Thus, the control module 220 can compare the measured values with the reference values to determine whether or not the signal is NLOS.

In a further arrangement, to determine whether the signal is NLOS or not, the control module 220 measures the radio propagation metrics, as previously outlined, a position/direction of the LEO satellite, and surrounding object information (i.e., locations of static/dynamic objects). In yet a further approach, the control module 220 measures relative radio propagation metrics using two or more LEO satellites. The control module 220 may determine a Time Difference of Arrival (TDoA) for which the two satellites transmit signals at the same time (i.e., synchronized transmissions). Similarly, the control module 220 determines the relative metrics according to a difference of AoAs, AoDs, RTTs, Doppler shifts, carrier phases, and so on between the two satellites. From this information, in combination with a position of the vehicle 100, a current position/direction of the satellites estimated from satellite trajectories, and surrounding dynamic/static object information, the control module 220 is able to determine whether the signal is NLOS or not. Additionally, it should be appreciated that while specific examples of input information are provided, in other approaches, the control module 220 may employ additional data. In one example, the additional data includes information about the path, such as the number of paths, type of each path (e.g., single reflection, double reflection, diffraction, etc.), absolute/relative time-of-arrival of each path, and so on.

Other arrangements involve the use of ray tracing and/or machine learning by the control module 220 to determine whether the signal is NLOS. In the example of the machine learning approach, the control module 220 may employ the model 260, which may be a neural network, decision tree, support vector machine, ensemble learning model, or another machine-learning model that is able to process the data into determinations about LOS versus NLOS. In the instance of both ray-tracing and machine learning, the control module 220 uses the sensor data 240, the parameters 250, and/or existing 3D mappings of the static objects in the environment to, for example, reconstruct, either explicitly or in an abstract context, a 3D mapping of the environment. From this, the control module 220 is able to apply ray-tracing to derive a path of the signal and determine whether it is NLOS or not.

The control module 220 then estimates the position of the terminal (vehicle 100) according to whether the signal is LOS or NLOS and by using a compensation parameter when the signal NLOS. For example, to determine the position of the vehicle 100, the control module 220 uses one or more of the following the parameters 250, path information of the LEO signal, the sensor data 240, position estimates or radio propagation metrics from other positioning methods (e.g., positioning based on GNSS, Wi-Fi, cellular, Bluetooth, UWB, V2X, sidelink, etc.) as a supplemental signal to refine a determination, and/or a previous position estimate. In general, the use of the other modalities or prior position information is employed to provide a seed for determining the current position or as a way to refine/improve the other determination of position. In addition to the above, the control module 220 may further consider additional information for NLOS signals, such as a path of the signal to compensate for positioning error due to the reflections.

Thus, the system 170 may use different configurations of the noted information. In one configuration, the control module 220 uses estimated positions of the LEO satellite(s) derived from ephemeris or known trajectory of the satellite(s) and one or more radio propagation metrics (e.g., parameters 250). In another arrangement, the control module 220 uses a signal processing method (e.g., Kalman filter, particle filter, etc.) to fuse multiple sensor measurements and position estimates to derive the current position of the vehicle 100.

In yet a further approach, the control module 220 estimates the current position from multiple information sources. For example, the control module 220 uses the measure radio propagation metrics, GNSS position information, onboard sensor information and determines the final position estimate from the multiple position estimates using, for example, a minimization of a mean squared error. In a further configuration, the control module 220 shares the radio propagation metrics and/or position estimates with a location management server or another terminal to calculate the current position of the vehicle 100. When the control module 220 determines the signal is NLOS and is reflected by RIS, the control module 220 uses a position of the RIS, a direction of the RIS, and a reflection angle of the RIS to account for the NLOS path and compensate for positioning error due to the NLOS signal. The control module 220 may use similar information from multiple RIS in determining the position, which is separately compensated. In this way, the control module 220 can account for NLOS signals in multiple contexts to permit the use of LEO satellite signals for positioning.

As an additional consideration, the initiation of determining the position and the associated information may occur either periodically, or aperiodically, according to different triggering events. The trigger events can include, for example, detecting that a GNSS signal is not available or sufficiently accurate, detecting NLOS for a GNSS signal, detecting a GNSS signal with a signal strength below a defined threshold, detecting the vehicle 100 entering a predefined area (i.e., a geofenced area associated with an urban canyon), detecting the unavailability of other positioning modalities (e.g., V2X positioning, sidelink, cellular-based positioning, etc.), detecting positioning accuracy below a defined threshold without the use of LEO satellite signals, and detecting misalignment of a beam direction toward an LEO satellite. Thus, the presently described arrangements may be employed to facilitate improved positioning or to provide positioning when otherwise unavailable.

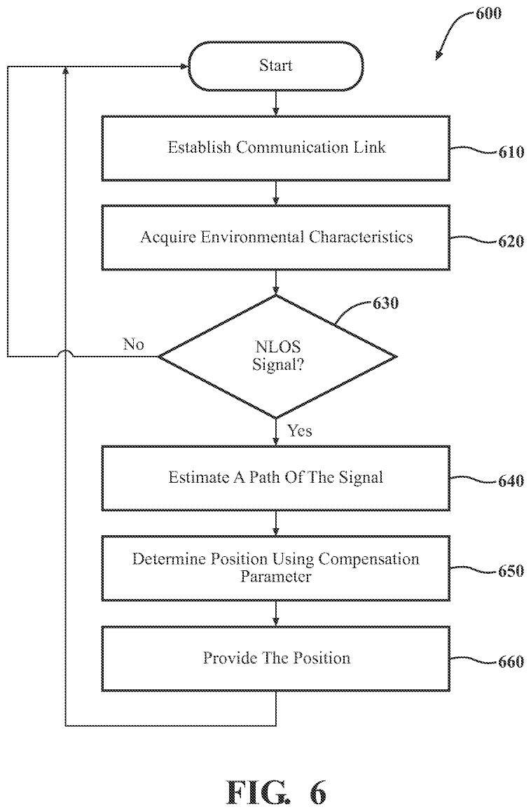

FIG. 6 illustrates a flowchart of a method 600 that is associated with using LEO satellites to determine the position of a device. Method 600 will be discussed from the perspective of the positioning system 170 of FIGS. 1-2. While method 600 is discussed in combination with the positioning system 170, it should be appreciated that the method 600 is not limited to being implemented within the positioning system 170 but is instead one example of a system that may implement the method 600. Furthermore, while the method is illustrated as a generally serial process, various aspects of the method 600 can execute in parallel to perform the noted functions.

At 610, the control module 220 establishes a communication link from a device (e.g., vehicle 100) to a low-Earth orbit (LEO) satellite. It should be noted that while a single LEO satellite is mentioned, the control module 220 may establish communication links with multiple different LEO satellites and perform the method 600 in relation to each. In any case, the control module 220 establishes the communication link using a beam pairing or other beam management procedure. As previously described, the process of establishing the communication link may involve different configurations that utilize different sets of information depending on the particular context. Whichever approach is undertaken, the control module 220 functions to at least identify the LEO satellite via receiving a signal from the LEO satellite from which further information can be derived as discussed further subsequently.

At 620, the control module 220 acquires environmental characteristics (e.g., the sensor data 240 and the parameters 250) associated with the vehicle 100 and the LEO satellite. As previously described in detail, the control module 220 controls various sensors of the vehicle 100, such as environmental sensors that perceive a surrounding environment of the vehicle 100 in order to detect a presence of dynamic objects that can interfere by reflecting or blocking the signal. The control module 220 may further acquire the sensor data 240 from vehicle sensors, such as IMU, wheel speed sensors, and so on, that provide for including information about the vehicle 100 itself so that the control module 220 can determine a geospatial relationship between dynamic objects and the vehicle 100, the vehicle 100 and the LEO satellites, the vehicle 100 and static obstacles, and so on. In general, the control module 220 can use the sensor data 240 to inform itself about physical relationships between the various elements (e.g., objects, satellites, etc.) via generating a 3D mapping and/or to otherwise define geometric relationships therebetween. The control module 220 further acquires signal information that includes measurements about the signal from the LEO satellite. The signal information can include a radio propagation metric derived from the signal, path information about the signal, sensor data from the device, a prior position estimate of the device, and ancillary position information. These elements may be wholly derived from the signal itself or supplemented using information from the sensor data 240. That is, the control module 220 may use at least a portion of the sensor data 240 to determine aspects such as the signal path according to, for example, ray tracing. In any case, the information collected and/or derived at 620 may be acquired in parallel with the various functions described herein.

At 630, the control module 220 determines whether a signal from the LEO satellite is a non-line-of-sight (NLOS) signal according to the environmental characteristics. As previously described in relation to FIG. 2, the control module 220 may undertake multiple different approaches to determining whether the signal is NLOS or not. In particular, the identification of dynamic objects can be an important aspect of identifying whether the signal is NLOS. Thus, the control module 220 identifies whether a dynamic object is present in a surrounding environment and blocks a line-of-sight (LOS) to the LEO satellite, in one embodiment, according to at least the sensor data 240 that facilitates mapping a geometric relationships therebetween. Moreover, in the case of a RIS, the control module 220 identifies whether the signal is being reflected by a RIS and is thus a NLOS signal. It should be appreciated that in one or more occurrences, the control module 220 may determine the presence of dynamic objects and the path of the signal along with identifying the presence of a RIS. Thus, the control module 220 determines occurrences of multiple reflections of the signal. If the signal is determined to be NLOS, then the control module 220 proceeds to determining a compensation parameter at 640. Otherwise, the control module 220 proceeds to determining a position of the vehicle 100 using information relating to an LOS signal, such as propagation metrics.

At 640, the control module 220 determines the compensation parameter by estimating a path of the signal. The compensation parameter provides for correcting for positioning error due to the signal being NLOS (i.e., due to the signal reflecting from one or more surfaces in the environment). Because the reflections alter measured aspects of the signal and also a perceived beam direction, the control module 220 determines these aspects in order to compensate for errors that they introduce into the positioning. Thus, as outlined previously, in the case of a dynamic object, the control module 220 uses the sensor data 240 to identify a location and shape of the object in the surrounding environment. The control module 220 can then relate the relative position of the vehicle 100, the LEO satellite, and the dynamic object while using known parameters about the signal to reconstruct a path of the reflected signal. In this way, the control module 220 accounts for a blockage from the dynamic object and can subsequently correct for positioning errors.

With particular reference to accounting for NLOS signals that result from dynamic objects in the surrounding environment, it should be appreciated that approaches, such as GNSS shadow matching, generally only consider static objects (e.g., buildings) as blocking/reflecting objects. Thus, the present approach accounts for dynamic objects in an NLOS context by leveraging available sensor data (e.g., data from sensor system 120) to actively detecting dynamic objects in the surrounding environment and determine attributes (e.g., size, position, speed, heading, etc.) of the dynamic objects. In further approaches, the control module 220 may separately or additionally also acquire active determinations (i.e., detections and attributes) from other sources (e.g., other vehicles, infrastructure-based sensors, etc.) via V2X or another communication approach. From this data, the control module 220 is able to estimate the relative distance and relative angle to dynamic objects from which the control module 220 can determine whether the LEO satellite is blocked from a direct line-of-sight (LOS) with the vehicle 100, and thus the signal is reflected. Accordingly, the control module 220 then estimates the NLOS path between the vehicle 100 and the LEO satellite by assuming blockage/reflection and thereby deriving the compensation parameter to account for the positioning error.

In a similar manner, the control module 220 uses information about a reconfigurable intelligent surface (RIS) that intentionally reflects the signal to derive the compensation parameters. In this case, the control module 220 can reconstruct the path from the RIS vehicle 100 to the RIS and the satellite in order to compensate for the positioning error. In particular, other approaches may assume a static reflecting angle from the RIS. However, because of the manner in which the LEO satellite operates, the reflection angle from the LEO satellite with a RIS dynamically changes. Accordingly, the reflection angle for the signal and the incident angle in relation to the RIS are not necessarily equal. To account for this, the control module 220 uses a position of the RIS, a direction of the RIS, and the reflection angle currently used by the RIS to determine whether the signal is reflected by the RIS or not. When the signal is reflected by the RIS, the control module 220 estimates the NLOS path by compensating for the NLOS signal according to the current values (e.g., the current angle of reflection, etc.) to generate the compensation parameter. In this way, the control module 220 is able to account for NLOS signals in relation to dynamic elements.

At 650, the control module 220 computes a position of the vehicle 100 using the signal and a compensation parameter when the signal is NLOS. That is, the control module 220 can use the estimated path along with the parameters 250, which can include measured aspects of the signal typically used in determining the position from a LOS signal. Thus, reconstructing the path can function as the compensation parameter.

At 660, the control module 220 provides the position. It should be appreciated that the position can be used in many different ways. Within the context of the vehicle 100, the control module 220 can electronically communicate the position to one or more subsystems within the vehicle 100 to facilitate functions, such as navigation, autonomous operation, and so on. In this way, the positioning system 170 is able to integrate information from LEO satellites with the subsystems and improve the determination of a location of the vehicle 100, thereby improving the operation of the subsystems that rely on such information.

FIG. 1 will now be discussed in full detail as an example environment within which the system and methods disclosed herein may operate. In some instances, the vehicle 100 is configured to switch selectively between an autonomous mode, one or more semi-autonomous operational modes, and/or a manual mode. Of course, in further aspects, the vehicle 100 may be a manually driven vehicle that may or may not include one or more driving assistance systems, such as active cruise control, lane-keeping assistance, crash avoidance, and so on. In any case, “manual mode” means that all of or a majority of the navigation and/or maneuvering of the vehicle is performed according to inputs received from a user (e.g., human driver). In one or more arrangements, the vehicle 100 can be a conventional vehicle that is configured to operate in only a manual mode.

In one or more embodiments, the vehicle 100 is an autonomous vehicle. As used herein, “autonomous vehicle” refers to a vehicle that operates in an autonomous mode. “Autonomous mode” refers to navigating and/or maneuvering the vehicle 100 along a travel route using one or more computing systems to control the vehicle 100 with minimal or no input from a human driver. In one or more embodiments, the vehicle 100 is highly automated or completely automated. In one embodiment, the vehicle 100 is configured with one or more semi-autonomous operational modes in which one or more computing systems perform a portion of the navigation and/or maneuvering of the vehicle along a travel route, and a vehicle operator (i.e., driver) provides inputs to the vehicle to perform a portion of the navigation and/or maneuvering of the vehicle 100 along a travel route.

The vehicle 100 can include one or more processors 110. In one or more arrangements, the processor(s) 110 can be a main processor of the vehicle 100. For instance, the processor(s) 110 can be an electronic control unit (ECU). The vehicle 100 can include one or more data stores 115 for storing one or more types of data. The data store 115 can include volatile and/or non-volatile memory. Examples of suitable data stores 115 include RAM (Random Access Memory), flash memory, ROM (Read Only Memory), PROM (Programmable Read-Only Memory), EPROM (Erasable Programmable Read-Only Memory), EEPROM (Electrically Erasable Programmable Read-Only Memory), registers, magnetic disks, optical disks, hard drives, or any other suitable storage medium, or any combination thereof. The data store 115 can be a component of the processor(s) 110, or the data store 115 can be operatively connected to the processor(s) 110 for use thereby. The term “operatively connected,” as used throughout this description, can include direct or indirect connections, including connections without direct physical contact.

In one or more arrangements, the one or more data stores 115 can include map data 116. The map data 116 can include maps of one or more geographic areas. In some instances, the map data 116 can include information or data on roads, traffic control devices, road markings, structures, features, and/or landmarks in the one or more geographic areas. The map data 116 can be in any suitable form. In some instances, the map data 116 can include aerial views of an area. In some instances, the map data 116 can include ground views of an area, including 360-degree ground views. The map data 116 can include measurements, dimensions, distances, and/or information for one or more items included in the map data 116 and/or relative to other items included in the map data 116. The map data 116 can include a digital map with information about road geometry. The map data 116 can be high quality and/or highly detailed.

In one or more arrangements, the map data 116 can include one or more terrain maps 117. The terrain map(s) 117 can include information about the ground, terrain, roads, surfaces, and/or other features of one or more geographic areas. The terrain map(s) 117 can include elevation data in the one or more geographic areas. The map data 116 can be high quality and/or highly detailed. The terrain map(s) 117 can define one or more ground surfaces, which can include paved roads, unpaved roads, land, and other things that define a ground surface.

In one or more arrangements, the map data 116 can include one or more static obstacle maps 118. The static obstacle map(s) 118 can include information about one or more static obstacles located within one or more geographic areas. A “static obstacle” is a physical object whose position does not change or substantially change over a period of time and/or whose size does not change or substantially change over a period of time. Examples of static obstacles include trees, buildings, curbs, fences, railings, medians, utility poles, statues, monuments, signs, benches, furniture, mailboxes, large rocks, hills. The static obstacles can be objects that extend above ground level. The one or more static obstacles included in the static obstacle map(s) 118 can have location data, size data, dimension data, material data, and/or other data associated with it. The static obstacle map(s) 118 can include measurements, dimensions, distances, and/or information for one or more static obstacles. The static obstacle map(s) 118 can be high quality and/or highly detailed. The static obstacle map(s) 118 can be updated to reflect changes within a mapped area.

The one or more data stores 115 can include sensor data 119. In this context, “sensor data” means any information about the sensors that the vehicle 100 is equipped with, including the capabilities and other information about such sensors. As will be explained below, the vehicle 100 can include the sensor system 120. The sensor data 119 can relate to one or more sensors of the sensor system 120. As an example, in one or more arrangements, the sensor data 119 can include information on one or more LIDAR sensors 124 of the sensor system 120.

In some instances, at least a portion of the map data 116 and/or the sensor data 119 can be located in one or more data stores 115 located onboard the vehicle 100. Alternatively, or in addition, at least a portion of the map data 116 and/or the sensor data 119 can be located in one or more data stores 115 that are located remotely from the vehicle 100.

As noted above, the vehicle 100 can include the sensor system 120. The sensor system 120 can include one or more sensors. “Sensor” means any device, component and/or system that can detect, and/or sense something. The one or more sensors can be configured to detect, and/or sense in real-time. As used herein, the term “real-time” means a level of processing responsiveness that a user or system senses as sufficiently immediate for a particular process or determination to be made, or that enables the processor to keep up with some external process.

In arrangements in which the sensor system 120 includes a plurality of sensors, the sensors can work independently from each other. Alternatively, two or more of the sensors can work in combination with each other. In such a case, the two or more sensors can form a sensor network. The sensor system 120 and/or the one or more sensors can be operatively connected to the processor(s) 110, the data store(s) 115, and/or another element of the vehicle 100 (including any of the elements shown in FIG. 1). The sensor system 120 can acquire data of at least a portion of the external environment of the vehicle 100 (e.g., nearby vehicles).

The sensor system 120 can include various types of sensors. Various examples of different types of sensors will be described herein. However, it will be understood that the embodiments are not limited to the particular sensors described. The sensor system 120 can include one or more vehicle sensors 121. The vehicle sensor(s) 121 can detect, determine, and/or sense information about the vehicle 100 itself. In one or more arrangements, the vehicle sensor(s) 121 can be configured to detect, and/or sense position and orientation changes of the vehicle 100, such as, for example, based on inertial acceleration. In one or more arrangements, the vehicle sensor(s) 121 can include one or more accelerometers, one or more gyroscopes, an inertial measurement unit (IMU), a dead-reckoning system, a global navigation satellite system (GNSS), a global positioning system (GPS), a navigation system 147, and/or other suitable sensors. The vehicle sensor(s) 121 can be configured to detect, and/or sense one or more characteristics of the vehicle 100. In one or more arrangements, the vehicle sensor(s) 121 can include a speedometer to determine a current speed of the vehicle 100.

Alternatively, or in addition, the sensor system 120 can include one or more environment sensors 122 configured to acquire, and/or sense driving environment data. “Driving environment data” includes data or information about the external environment in which an autonomous vehicle is located or one or more portions thereof. For example, the one or more environment sensors 122 can be configured to detect, quantify and/or sense obstacles in at least a portion of the external environment of the vehicle 100 and/or information/data about such obstacles. Such obstacles may be stationary objects and/or dynamic objects. The one or more environment sensors 122 can be configured to detect, measure, quantify and/or sense other things in the external environment of the vehicle 100, such as, for example, lane markers, signs, traffic lights, traffic signs, lane lines, crosswalks, curbs proximate the vehicle 100, off-road objects, etc.

Various examples of sensors of the sensor system 120 will be described herein. The example sensors may be part of the one or more environment sensors 122 and/or the one or more vehicle sensors 121. However, it will be understood that the embodiments are not limited to the particular sensors described.

As an example, in one or more arrangements, the sensor system 120 can include one or more radar sensors 123, one or more LIDAR sensors 124, one or more sonar sensors 125, and/or one or more cameras 126. In one or more arrangements, the one or more cameras 126 can be high dynamic range (HDR) cameras or infrared (IR) cameras.

The vehicle 100 can include an input system 130. An “input system” includes any device, component, system, element, or arrangement or groups thereof that enable information/data to be entered into a machine. The input system 130 can receive an input from a vehicle passenger (e.g., a driver or a passenger). The vehicle 100 can include an output system 135. An “output system” includes any device, component, or arrangement or groups thereof that enable information/data to be presented to a vehicle passenger (e.g., a person, a vehicle passenger, etc.).

The vehicle 100 can include one or more vehicle systems 140. Various examples of the one or more vehicle systems 140 are shown in FIG. 1. However, the vehicle 100 can include more, fewer, or different vehicle systems. It should be appreciated that although particular vehicle systems are separately defined, each or any of the systems or portions thereof may be otherwise combined or segregated via hardware and/or software within the vehicle 100. The vehicle 100 can include a propulsion system 141, a braking system 142, a steering system 143, throttle system 144, a transmission system 145, a signaling system 146, and/or a navigation system 147. Each of these systems can include one or more devices, components, and/or a combination thereof, now known or later developed.

The navigation system 147 can include one or more devices, applications, and/or combinations thereof, now known or later developed, configured to determine the geographic location of the vehicle 100 and/or to determine a travel route for the vehicle 100. The navigation system 147 can include one or more mapping applications to determine a travel route for the vehicle 100. The navigation system 147 can include a global positioning system, a local positioning system, or a geolocation system.

The processor(s) 110, the positioning system 170, and/or the automated driving module(s) 160 can be operatively connected to communicate with the various vehicle systems 140 and/or individual components thereof. For example, returning to FIG. 1, the processor(s) 110 and/or the automated driving module(s) 160 can be in communication to send and/or receive information from the various vehicle systems 140 to control the movement, speed, maneuvering, heading, direction, etc. of the vehicle 100. The processor(s) 110, and/or the automated driving module(s) 160 may control some or all of these vehicle systems 140 and, thus, may be partially or fully autonomous.

The processor(s) 110, and/or the automated driving module(s) 160 can be operatively connected to communicate with the various vehicle systems 140 and/or individual components thereof. For example, returning to FIG. 1, the processor(s) 110, the positioning system 170, and/or the automated driving module(s) 160 can be in communication to send and/or receive information from the various vehicle systems 140 to control the movement, speed, maneuvering, heading, direction, etc. of the vehicle 100. The processor(s) 110, the positioning system 170, and/or the automated driving module(s) 160 may control some or all of these vehicle systems 140.

The processor(s) 110, and/or the automated driving module(s) 160 may be operable to control the navigation and/or maneuvering of the vehicle 100 by controlling one or more of the vehicle systems 140 and/or components thereof. For instance, when operating in an autonomous mode, the processor(s) 110, and/or the automated driving module(s) 160 can control the direction and/or speed of the vehicle 100. The processor(s) 110, and/or the automated driving module(s) 160 can cause the vehicle 100 to accelerate (e.g., by increasing the supply of fuel provided to the engine), decelerate (e.g., by decreasing the supply of fuel to the engine and/or by applying brakes) and/or change direction (e.g., by turning the front two wheels). As used herein, “cause” or “causing” means to make, force, compel, direct, command, instruct, and/or enable an event or action to occur or at least be in a state where such event or action may occur, either in a direct or indirect manner.

The vehicle 100 can include one or more actuators 150. The actuators 150 can be any element or combination of elements operable to modify, adjust and/or alter one or more of the vehicle systems 140 or components thereof to responsive to receiving signals or other inputs from the processor(s) 110 and/or the automated driving module(s) 160. Any suitable actuator can be used. For instance, the one or more actuators 150 can include motors, pneumatic actuators, hydraulic pistons, relays, solenoids, and/or piezoelectric actuators, just to name a few possibilities.

The vehicle 100 can include one or more modules, at least some of which are described herein. The modules can be implemented as computer-readable program code that, when executed by a processor 110, implement one or more of the various processes described herein. One or more of the modules can be a component of the processor(s) 110, or one or more of the modules can be executed on and/or distributed among other processing systems to which the processor(s) 110 is operatively connected. The modules can include instructions (e.g., program logic) executable by one or more processor(s) 110. Alternatively, or in addition, one or more data store 115 may contain such instructions.

In one or more arrangements, one or more of the modules described herein can include artificial or computational intelligence elements, e.g., neural network, fuzzy logic or other machine learning algorithms. Further, in one or more arrangements, one or more of the modules can be distributed among a plurality of the modules described herein. In one or more arrangements, two or more of the modules described herein can be combined into a single module.

The vehicle 100 can include one or more automated driving modules 160. The automated driving module(s) 160 can be configured to receive data from the sensor system 120 and/or any other type of system capable of capturing information relating to the vehicle 100 and/or the external environment of the vehicle 100. In one or more arrangements, the automated driving module(s) 160 can use such data to generate one or more driving scene models. The automated driving module(s) 160 can determine the position and velocity of the vehicle 100. The automated driving module(s) 160 can determine the location of obstacles, obstacles, or other environmental features, including traffic signs, trees, shrubs, neighboring vehicles, pedestrians, etc.

The automated driving module(s) 160 can be configured to receive, and/or determine location information for obstacles within the external environment of the vehicle 100 for use by the processor(s) 110, and/or one or more of the modules described herein to estimate position and orientation of the vehicle 100, vehicle position in global coordinates based on signals from a plurality of satellites, or any other data and/or signals that could be used to determine the current state of the vehicle 100 or determine the position of the vehicle 100 with respect to its environment for use in either creating a map or determining the position of the vehicle 100 in respect to map data.

The automated driving module(s) 160 either independently or in combination with the positioning system 170 can be configured to determine travel path(s), current autonomous driving maneuvers for the vehicle 100, future autonomous driving maneuvers and/or modifications to current autonomous driving maneuvers based on data acquired by the sensor system 120, driving scene models, and/or data from any other suitable source such as determinations from the sensor data. “Driving maneuver” means one or more actions that affect the movement of a vehicle. Examples of driving maneuvers include: accelerating, decelerating, braking, turning, moving in a lateral direction of the vehicle 100, changing travel lanes, merging into a travel lane, and/or reversing, just to name a few possibilities. The automated driving module(s) 160 can be configured to implement determined driving maneuvers. The automated driving module(s) 160 can cause, directly or indirectly, such autonomous driving maneuvers to be implemented. As used herein, “cause” or “causing” means to make, command, instruct, and/or enable an event or action to occur or at least be in a state where such event or action may occur, either in a direct or indirect manner. The automated driving module(s) 160 can be configured to execute various vehicle functions and/or to transmit data to, receive data from, interact with, and/or control the vehicle 100 or one or more systems thereof (e.g., one or more of vehicle systems 140).

Detailed embodiments are disclosed herein. However, it is to be understood that the disclosed embodiments are intended only as examples. Therefore, specific structural and functional details disclosed herein are not to be interpreted as limiting, but merely as a basis for the claims and as a representative basis for teaching one skilled in the art to variously employ the aspects herein in virtually any appropriately detailed structure. Further, the terms and phrases used herein are not intended to be limiting but rather to provide an understandable description of possible implementations. Various embodiments are shown in FIGS. 1-6, but the embodiments are not limited to the illustrated structure or application.

The flowcharts and block diagrams in the figures illustrate the architecture, functionality, and operation of possible implementations of systems, methods, and computer program products according to various embodiments. In this regard, each block in the flowcharts or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved.

The systems, components and/or processes described above can be realized in hardware or a combination of hardware and software and can be realized in a centralized fashion in one processing system or in a distributed fashion where different elements are spread across several interconnected processing systems. Any kind of processing system or another apparatus adapted for carrying out the methods described herein is suited. A typical combination of hardware and software can be a processing system with computer-usable program code that, when being loaded and executed, controls the processing system such that it carries out the methods described herein. The systems, components and/or processes also can be embedded in a computer-readable storage, such as a computer program product or other data programs storage device, readable by a machine, tangibly embodying a program of instructions executable by the machine to perform methods and processes described herein. These elements also can be embedded in an application product that comprises all the features enabling the implementation of the methods described herein and, when loaded in a processing system, is able to carry out these methods.

Furthermore, arrangements described herein may take the form of a computer program product embodied in one or more computer-readable media having computer-readable program code embodied, e.g., stored, thereon. Any combination of one or more computer-readable media may be utilized. The computer-readable medium may be a computer-readable signal medium or a computer-readable storage medium. The phrase “computer-readable storage medium” means a non-transitory storage medium. A computer-readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer-readable storage medium would include the following: a portable computer diskette, a hard disk drive (HDD), a solid-state drive (SSD), a read-only memory (ROM), an erasable programmable read-only memory (EPROM or Flash memory), a portable compact disc read-only memory (CD-ROM), a digital versatile disc (DVD), an optical storage device, a magnetic storage device, or any suitable combination of the foregoing. In the context of this document, a computer-readable storage medium may be any tangible medium that can contain or store a program for use by or in connection with an instruction execution system, apparatus, or device.

Generally, modules, as used herein, include routines, programs, objects, components, data structures, and so on that perform particular tasks or implement particular data types. In further aspects, a memory generally stores the noted modules. The memory associated with a module may be a buffer or cache embedded within a processor, a RAM, a ROM, a flash memory, or another suitable electronic storage medium. In still further aspects, a module as envisioned by the present disclosure is implemented as an application-specific integrated circuit (ASIC), a hardware component of a system on a chip (SoC), as a programmable logic array (PLA), or as another suitable hardware component that is embedded with a defined configuration set (e.g., instructions) for performing the disclosed functions.

Program code embodied on a computer-readable medium may be transmitted using any appropriate medium, including but not limited to wireless, wireline, optical fiber, cable, RF, etc., or any suitable combination of the foregoing. Computer program code for carrying out operations for aspects of the present arrangements may be written in any combination of one or more programming languages, including an object-oriented programming language such as Java™, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer, or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The terms “a” and “an,” as used herein, are defined as one or more than one. The term “plurality,” as used herein, is defined as two or more than two. The term “another,” as used herein, is defined as at least a second or more. The terms “including” and/or “having,” as used herein, are defined as comprising (i.e., open language). The phrase “at least one of . . . and . . . ” as used herein refers to and encompasses any and all possible combinations of one or more of the associated listed items. As an example, the phrase “at least one of A, B, and C” includes A only, B only, C only, or any combination thereof (e.g., AB, AC, BC or ABC).

Aspects herein can be embodied in other forms without departing from the spirit or essential attributes thereof. Accordingly, reference should be made to the following claims, rather than to the foregoing specification, as indicating the scope hereof.

What is claimed is:

1. A positioning system, comprising:
one or more processors; and
a memory communicably coupled to the one or more processors and storing:
a control module including instructions that, when executed by the one or more processors, cause the one or more processors to:
establish a communication link from a device to a non-terrestrial network (NTN) node;
acquire environmental characteristics associated with the device and the NTN node;
determine whether a signal from the NTN node is a non-line-of-sight (NLOS) signal according to the environmental characteristics;
compute a position of the device using the signal and a compensation parameter when the signal is NLOS; and
provide the position.

2. The positioning system of claim 1, wherein the instructions to compute the position of the device include instructions to estimate a path of the signal when the signal is NLOS to generate a compensation parameter that corrects for positioning error due to the signal being NLOS, and
wherein the NTN node is one of: a low-Earth orbit (LEO) satellite, a medium Earth orbit (MEO) satellite, and a geostationary orbit (GEO) satellite.

3. The positioning system of claim 2, wherein the instructions to estimate the path include instructions to determine the path according to a blockage from a dynamic object detected in a surrounding environment of the device that is reflecting the signal, the dynamic object being an object that moves.

4. The positioning system of claim 2, wherein the instructions to estimate the path include instructions to assume that a reconfigurable intelligent surface (RIS) reflects the signal from the NTN node to the device and determine the path according to the signal reflecting from a location of the RIS in relation to a dynamic position of the NTN node.

5. The positioning system of claim 1, wherein the instructions to determine whether the signal is NLOS include instructions to identify i) whether a dynamic object is present in a surrounding environment of the device that blocks a line-of-sight (LOS) to the NTN node, and ii) whether a reconfigurable intelligent surface (RIS) is reflecting the signal of the NTN node, and
wherein the instructions to determine whether the signal is NLOS include instructions to analyze the environmental characteristics that include sensor data perceiving the dynamic object, the sensor data representing at least one of: a size of the dynamic object, a position of the dynamic object, a speed of the dynamic object, and a heading of the dynamic object.

6. The positioning system of claim 1, wherein the instructions to acquire the environmental characteristics include instructions to acquire sensor data from environmental sensors of the device about a surrounding environment of the device in order to detect a presence of dynamic objects that can interfere with receiving the signal, and acquiring signal information that includes measurements about the signal from the NTN node.

7. The positioning system of claim 1, wherein the instructions to provide the position include instructions to communicate the position to a subsystem within an apparatus in which the device is integrated to facilitate navigation, and
wherein the apparatus is one of: a ground vehicle, a maritime vehicle, an aerial vehicle, a space vehicle, a mobile device, user equipment, and a network infrastructure node.

8. The positioning system of claim 1, wherein the instructions to acquire the environmental characteristics include instructions to acquire at least one of: a radio propagation metric derived from the signal, path information about the signal, sensor data from the device, including one or more signals received from another device, a prior position estimate of the device, and ancillary position information.

9. A non-transitory computer-readable medium storing instructions that, when executed by one or more processors, cause the one or more processors to:
establish a communication link from a device to a non-terrestrial network (NTN) node;
acquire environmental characteristics associated with the device and the NTN node;
determine whether a signal from the NTN node is a non-line-of-sight (NLOS) signal according to the environmental characteristics;
compute a position of the device using the signal and a compensation parameter when the signal is NLOS; and
provide the position.

10. The non-transitory computer-readable medium of claim 9, wherein the instructions to compute the position of the device include instructions to estimate a path of the signal when the signal is NLOS to generate a compensation parameter that corrects for positioning error due to the signal being NLOS, and
wherein the NTN node is one of: a low-Earth orbit (LEO) satellite, a medium Earth orbit (MEO) satellite, and a geostationary orbit (GEO) satellite.

11. The non-transitory computer-readable medium of claim 10, wherein the instructions to estimate the path include instructions to determine the path according to a blockage from a dynamic object detected in a surrounding environment of the device that is reflecting the signal, the dynamic object being an object that moves.

12. The non-transitory computer-readable medium of claim 10, wherein the instructions to estimate the path include instructions to assume that a reconfigurable intelligent surface (RIS) reflects the signal from the NTN node to the device and determine the path according to the signal reflecting from a location of the RIS in relation to a dynamic position of the NTN node.

13. The non-transitory computer-readable medium of claim 9, wherein the instructions to determine whether the signal is NLOS include instructions to identify i) whether a dynamic object is present in a surrounding environment of the device that blocks a line-of-sight (LOS) to the NTN node, and ii) whether a reconfigurable intelligent surface (RIS) is reflecting the signal of the NTN node, and
wherein the instructions to determine whether the signal is NLOS include instructions to analyze the environmental characteristics that include sensor data perceiving the dynamic object, the sensor data representing at least one of: a size of the dynamic object, a position of the dynamic object, a speed of the dynamic object, and a heading of the dynamic object.

14. A method, comprising:
establishing a communication link from a device to a non-terrestrial network (NTN) node;
acquiring environmental characteristics associated with the device and the NTN node;
determining whether a signal from the NTN node is a non-line-of-sight (NLOS) signal according to the environmental characteristics;
computing a position of the device using the signal and a compensation parameter when the signal is NLOS; and
providing the position.

15. The method of claim 14, wherein computing the position of the device includes estimating a path of the signal when the signal is NLOS to generate a compensation parameter that corrects for positioning error due to the signal being NLOS, and
wherein the NTN node is one of: a low-Earth orbit (LEO) satellite, a medium Earth orbit (MEO) satellite, and a geostationary orbit (GEO) satellite.

16. The method of claim 15, wherein estimating the path includes determining the path according to a blockage from a dynamic object detected in a surrounding environment of the device that is reflecting the signal, the dynamic object being an object that moves.

17. The method of claim 15, wherein estimating the path includes assuming that a reconfigurable intelligent surface (RIS) reflects the signal from the NTN node to the device and determining the path according to the signal reflecting from a location of the RIS in relation to a dynamic position of the NTN node.

18. The method of claim 14, wherein determining whether the signal is NLOS includes identifying i) whether a dynamic object is present in a surrounding environment of the device that blocks a line-of-sight (LOS) to the NTN node, and ii) whether a reconfigurable intelligent surface (RIS) is reflecting the signal of the NTN node, and
wherein determining whether the signal is NLOS includes analyzing the environmental characteristics that include sensor data perceiving the dynamic object, the sensor data representing at least one of: a size of the dynamic object, a position of the dynamic object, a speed of the dynamic object, and a heading of the dynamic object.

19. The method of claim 14, wherein acquiring the environmental characteristics includes acquiring sensor data from environmental sensors of the device about a surrounding environment of the device in order to detect a presence of dynamic objects that can interfere with receiving the signal, and acquiring signal information that includes measurements about the signal from the NTN node.

20. The method of claim 14, wherein providing the position includes communicating the position to a subsystem within an apparatus in which the device is integrated to facilitate navigation of the vehicle,
wherein the apparatus is one of: a ground vehicle, a maritime vehicle, an aerial vehicle, a space vehicle, a mobile device, user equipment, and a network infrastructure node, and
wherein acquiring the environmental characteristics includes acquiring at least one of: a radio propagation metric derived from the signal, path information about the signal, sensor data from the device, including one or more signals received from another device, a prior position estimate of the device, and ancillary position information.
